(19) United States
(12) Patent Application Publication
(10) Pub. No.: US 2006/0154621 A1
(43) Pub. Date: Jul. 13, 2006

(54) Method for transmitting signals in a radio communication system

(76) Inventors: Tobias Giebel, Wolfsburg (DE); Mattias Lampe, Alfeld (DE); Hermann Rohling, Wolfenbuttel (DE); Egon Schulz, Munchen (DE); Wolfgang Zirwas, Grobenzell (DE)

Correspondence Address: STAAS & HALSEY LLP, SUITE 700, 1201 NEW YORK AVENUE, N.W., WASHINGTON, DC, 20005, US

(21) Appl. No.: 10/527,188

(22) PCT Filed: Sep. 10, 2003
(86) PCT No.: PCT/EP03/10063

§ 371 Date: Dec. 1, 2005

(30) Foreign Application Priority Data
Sep. 10, 2002 (DE) 102 41 959.0

(51) Int. Cl. H04B 1/02; H04B 7/02

(52) U.S. Cl. 455/101

(57) ABSTRACT

Signals from a transmitting first radio station are transmitted to a receiving second radio station via at least two intermediate stations. Signaling of the configuration of the emission to the receiving second radio station is carried out between the at least two intermediate stations.

### CROSS REFERENCE TO RELATED APPLICATIONS

This application is based on and hereby claims priority to PCT Application No. PCT/EP2003/010063 filed Sep. 10, 2003 and German Application No.102 41 959.0 filed Sep. 10, 2002, the contents of which are hereby incorporated by reference.

### BACKGROUND OF THE INVENTION

The invention relates to a method for transmitting signals in a radio communication system.

Known ad-hoc networks usually have a poorer performance compared with known mobile radio systems. This is due in particular to the fact that where there is data transmission via a large number of multihop stations the frequencies used cannot be used again within a certain radius of these stations. This uncoordinated use of transmission resources has the disadvantage that data throughput is heavily dependent on location.

### SUMMARY OF THE INVENTION

One possible object isto advantageously develop known ad-hoc networks for efficient transmission over large distances.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 An MHSFN system with two hops and two intermediate stations

FIG. 2 An overview of various possible realizations of MHSFN systems

FIG. 3 A two-hop SFN system with intermediate stations

FIG. 4 A description of transmission channels

FIG. 5 An objective function for two intermediate stations

FIG. 6 A further objective function

FIG. 7 A three-hop SFN system with intermediate stations

FIG. 8 Clustering of several intermediate stations, and

FIG. 9 An example showing the application of a distributed antenna concept in an ad-hoc network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Methods for signal processing and signaling with data transmission in a multihop (MH) and single frequency network (SFN) radio communication system are described. SFNs are, for example, known from radio broadcasting systems such as Digital Video Broadcasting-Terrestrial (DVB-T) or Digital Audio Broadcasting (DAB) systems, with which a large area is covered by several base stations using the same transmission frequencies.

1. Description of System

The description is of a radio communication system having of a transmitting radio station, a receiving radio station and one or more intermediate stations or no intermediate station.

In a system of this kind, signals, for example data signals, are either transmitted directly from the transmitting radio station to the receiving radio station or via one or more intermediate stations. In this process, an intermediate station (EP—Extension Point) can forward the signals sent from the transmitting station (AP—Access Point) directly or indirectly via further intermediate stations to the receiving radio station (MT—Mobile Terminal). Forwarding via several stations is also known as multihop (MH). Furthermore, several intermediate stations can receive the same signal or data simultaneously and send them jointly, i.e. simultaneously and at the same frequency, directly to the receiving radio station or other intermediate stations with the aid of an SFN.

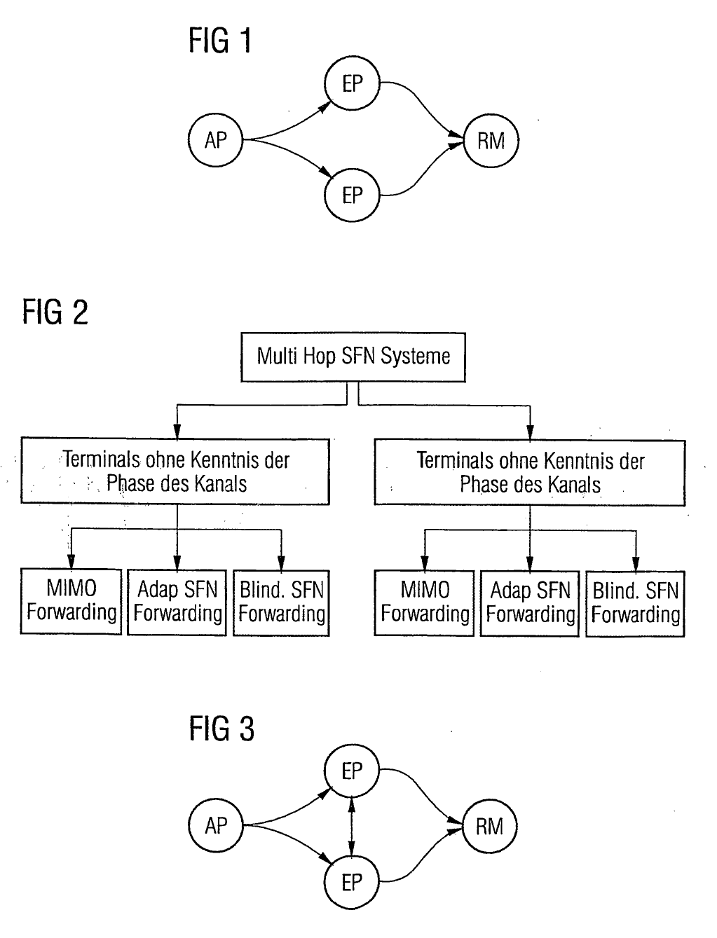

This system is referred to in the following as a multihop single frequency network (MHSFN). FIG. 1 shows an example of an MHSFN with a transmitting radio station AP, two hops via two intermediate stations EP and a receiving radio station RM. In this case, the two intermediate stations EP are shown by way of example within the transmission range of the transmitting radio station AP, that in a first step transmits data intended for the receiving radio station RM located outside the transmission range of the transmitting radio station AP to the intermediate stations EP. In a second step, the intermediate stations EP forward the data, simultaneously and at the same frequency, to the receiving radio station RM. The intermediate stations can, for example, be synchronized by the transmitting radio station, whereby a phase pre-equalization can be advantageously carried out at the location of the intermediate stations, in order to ensure constructive superpositioning of signals at the location of the receiving radio station. The advantage of a single frequency network of this kind is that the transmission range is increased by an achievable greater signal-to-noise ratio and the effect of shadowing is also reduced. Furthermore, transmission reliability is increased because even if one of the intermediate stations is shut down, for example by the user, data transmission to the receiving radio station is still ensured by the other active, forwarding intermediate stations.

1.1 Signal Processing and signaling in an MHSFN System

Signal processing methods, such as pre-equalization or equalization procedures, can advantageously be used in the intermediate stations ES in an MHSFN system. To increase the performance of these procedures, characteristic quantities can also be exchanged by signaling between the radio stations AP and/or RM and the intermediate stations EP. By this information, weighting factors, for example, can be determined in each intermediate station before forwarding to the receiving radio station, which advantageously achieves a higher signal-to-noise ratio at the location of the receiving radio station. Compared to simple phase pre-equalization without taking account of characteristic quantities, this can achieve a gain, because connections with lower signal-to-noise ratio values do not interfere with the signals received at the receiving radio station.

In this case, a distinction can basically be made between three signal processing or signaling concepts.

A first approach of a largely optimum signal processing is based on a knowledge of all received symbols and channel properties. In this concept, referred to in the following as Multiple Input Multiple Output (MIMO) forwarding, this is, however, associated with a very high signaling cost.

The second approach of signal processing is based merely on the knowledge of the channel properties. Only statistical characteristic quantities of the received symbols are required to be known. With this approach, information regarding the channel status is exchanged between the stations. Updating of this information in this case is, for example, necessary only if there is a significant change in the channel properties, and this can lead to an advantageous reduction in the signaling costs. This concept is referred to in the following as adapted SFN forwarding.

The third approach is signaling-free. The signal processing is based exclusively on the information available in the particular station or intermediate station or on characteristic quantities of the MHSFN system, such as channel attenuation and/or channel noise. No additional information on further or all intermediate stations is known. This concept is referred to in the following as blind SFN forwarding.

By an appropriate signal processing or special pre-equalization and/or equalization procedures in the intermediate stations, it is possible, for example, to achieve an advantageous constructive superposition of the signals at the location of the receiving radio station. To achieve this kind of in-phase superposition of the signals at the receiver, precise knowledge regarding the expected transmission channel must however be present and taken into account during signal processing. Reciprocal properties of the radio channel can sometimes be used in this case, that enable information on the behavior of the radio channel to be obtained on the basis of received signals. It must, however, be taken into account that the analog transmission channel is made up of the radio channel and the analog transmission or receiving front end. Whereas there is sufficient reciprocity of the radio channel, the transmission behavior of the transmission or reception front end can vary considerably particularly with regard to the phase response. Therefore, an in-phase prediction of the transmission channel can only be made if this difference is taken into account.

A distinction is made between two types of stations (terminals) in the following:
Terminals that have an in-phase prediction of the transmission channel and
terminals that do not have an in-phase prediction of the transmission channel.

FIG. 2 is an overview of the different realization possibilities of MHSFN systems. Combinations of these realizations are also possible in addition to the aforementioned concepts.

Different signaling processing algorithms can be advantageously used depending on the type of terminal and signaling concept employed. Various techniques of signal processing and pre-equalization and/or equalization procedures are described in the following with the aid of examples.

### EXAMPLES

To explain the aforementioned system concepts, examples of system realizations are described in the following.

A known orthogonal frequency division multiplex (OFDM) transmission system is used as a basis for the following examples, and the transmitter power of each individual subcarrier is also limited by a spectrum mask. The method is, however, not limited to these boundary conditions, but can be used in a similar manner in systems with different boundary conditions.

The named examples of boundary conditions enable a separate and independent investigation of an individual subcarrier, with it being possible to advantageously analyze and optimize the transmission performance of each subcarrier independent of other subcarriers of the OFDM system.

2.1 Two-Hop SFN

FIG. 3 shows a two-hop SFN system with two intermediate stations EP.

The methods described in the following are used to optimize the transmission performance. For this purpose, the signal-to-noise ratio of each subcarrier is, for example, maximized at the receiver SNR_{SFN}. Signaling protocols are also described that support an optimum forwarding of this kind.

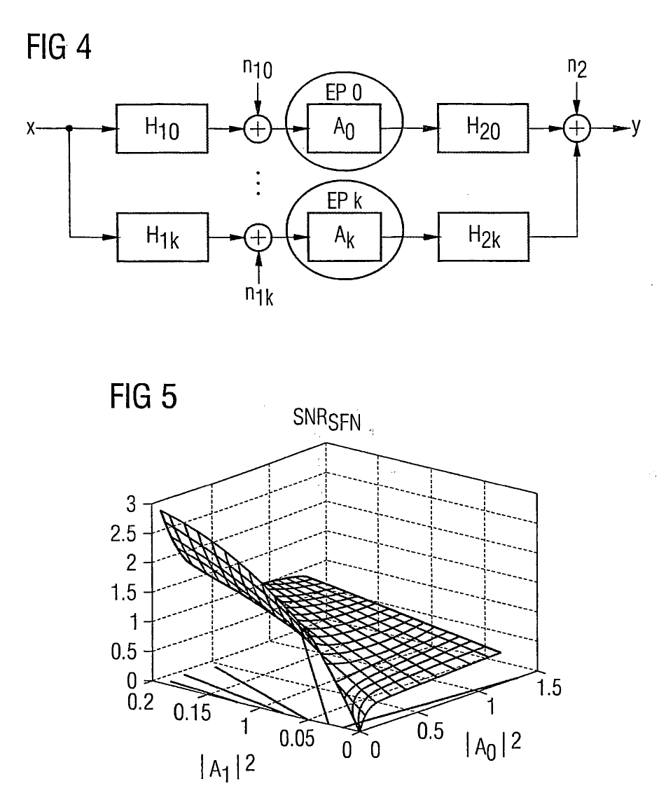

For an analytical description in accordance with FIG. 4, a nomenclature for the description of the transmission channels is specified. This describes transmission factors and noise terms for a subcarrier.

The transmission factor from the transmitting radio station to the intermediate station EP number k is designated H₁ₖ. Signal n₁ₖ describes the noise at the intermediate station EP number k. The number of intermediate stations EP is shown by K so that the index k runs from 0 to K-1. The noise power is shown as □₁ₖ² Index 1 indicates the first hop of the two-hop system. Correspondingly, H₂ₖ is the transmission factor from the intermediate station EP number k to the receiving radio station. Signal n₂ describes the noise at the receiving radio station. The noise power is shown as □₂². Index 2 indicates the second hop of the two-hop system. The complex factors Aₖ each describe a weighting in the intermediate station EP number k.

From this nomenclature and the boundary conditions of the transmitter power limiting to 1, we therefore get the following limits for the complex factors Ak
0≦|Aₖ|²≦1/(|H₁ₖ|²+□₁ₖ²).

2.2.1 Without Knowledge of the Channel Phases

In a first example, a system with intermediate stations EP without knowledge of the channel phases of the transmitting channel for forwarding is assumed.

Because the channel phases of the H2k are not known in the intermediate stations EP, a constructive superposition of the signals at the location of the receiving radio station cannot always be achieved. The received signals superpose each other more with a random phase, which means that only the performance of the received signals add in the middle. The signal-to-noise ratio at the receiver is therefore calculated as

$${SNR}_{SFN} = \frac{{\sum }_{k = 0}^{K - 1} {\vert {H}_{1 k} \vert}^{2} {\vert {H}_{2 k} \vert}^{2} {\vert {A}_{k} \vert}^{2}}{{σ}_{2}^{2} + {\sum }_{k = 0}^{K - 1} {σ}_{1 k}^{2} {\vert {H}_{2 k} \vert}^{2} {\vert {A}_{k} \vert}^{2}} .$$

The objective function (SNR_{SFN}) is now to be maximized using variations of the |Aₖ|². When doing so, note that the parameters |Aₖ|² are limited. Optimization is therefore to be carried out only in the validity range given by the limitation of |Aₖ|².

2.2.1.1 With Channel Parameters and Reception Value Signaling (MIMO Forwarding in Accordance with the First Approach)

Optimization of the signal-to-noise ratio SNR_{SFN} at the location of the receiver can be advantageously achieved with a signaling of channel parameters and reception values taking account of all system parameters.

2.2.1.2 With Channel Parameter Signaling (Adaptive SFN Forwarding in Accordance with the Second Approach)

The optimization of the signal-to-noise ratio SNR_{SFN} at the location of the receiver can be carried out by signaling channel parameters taking account of these system parameters.

For maximization, a preliminary investigation of the behavior of the objective function is helpful. This is to determine that the “height lines” of the objective function are “straight lines” of dimension K-1 or hyper levels of dimension K-1 in the R^{K}. This means, no “height lines” have a point characteristic. Because of this, the function cannot have a global maximum or minimum within the validity range. The function becomes maximum at the edge of the validity range.

Because the validity range is bounded by hyper levels in the R^{K}, the maximum of the objective function is to be found in a vertex of the validity range. In certain cases, the height line hyper level, that belongs to the maximum SNR_{SFN}, can lie on an adjacent hyper level. Because each point, and therefore also each vertex, has the same value on a height line, any vertex can be chosen in this case.

FIG. 5 is an example of an objective function, the SNR_{SFN}, shown for two intermediate stations relative to parameters |Aₖ|². The channel transmission factors were randomly chosen in this example. From FIG. 5 it can be seen that the height lines are straight lines and that the objective function is at a maximum in a vertex of the validity range.

This analysis shows that the optimum SNR_{SFN} is always reached in a vertex of the validity range. One vertex describes a parameter set |Aₖ|², where one or more intermediate stations EP transmit at maximum power (|Aₖ|²=1/(|Hₖ₁|²+□₁ₖ²)), but other intermediate stations EP perform no forwarding (|Aₖ|²=0). None of the intermediate stations transmits at a power between zero and the maximum value (0<|Aₖ|²<1/(|H₁ₖ|²+□₁ₖ²)). The maximizing of the SNR_{SFN} is thus achieved by a suitable choice of intermediate stations EP that transmit at maximum power.

The choice of active intermediate stations can, for example, be achieved with the aid of a selection criterion. If L+1 intermediate stations are chosen and transmit at maximum power, a rule can be defined that describes the conditions under which an intermediate station is to be switched off in order to increase the SNR_{SFN}. The intermediate station number L should, for example, then be precisely switched off if this would mean that the SNR_{SFN} would be increased or remain unchanged. If SNR_{SFN L} describes the signal-to-noise ratio when all intermediate stations (number 0 to number L) are transmitting and SNR_{SFN L-1} describes the signal-to-noise ratio if only one of the intermediate stations of number 0 to number L−1 is transmitting, this condition can be formulated as follows:

$${SNR}_{{SFN}_{L}} \leq {SNR}_{{SFN}_{L - 1}} ⇔ \frac{{\sum }_{k = 0}^{L} {\vert {H}_{1 k} \vert}^{2} {\vert {H}_{2 k} \vert}^{2} {\vert {A}_{k} \vert}^{2}}{{σ}_{2}^{2} + {\sum }_{k = 0}^{L} {σ}_{1 k}^{2} {\vert {H}_{2 k} \vert}^{2} {\vert {A}_{k} \vert}^{2}} \leq \frac{{\sum }_{k = 0}^{L - 1} {\vert {H}_{1 k} \vert}^{2} {\vert {H}_{2 k} \vert}^{2} {\vert {A}_{k} \vert}^{2}}{{σ}_{2}^{2} + {\sum }_{k = 0}^{L - 1} {σ}_{1 k}^{2} {\vert {H}_{2 k} \vert}^{2} {\vert {A}_{k} \vert}^{2}} ⇔ {SNR}_{{SFN}_{L}} \geq {SNR}_{1 L} = \frac{{\vert {H}_{1 L} \vert}^{2}}{{σ}_{1 L}^{2}}$$

This shows that intermediate station number L is to be switched off in cases where its received signal-to-noise ratio SNR_{1L} is less than the previous signal-to-noise ratio (SNR_{SFN L}) at the receiving radio station.

An algorithm with the following steps can be formulated on the basis of this knowledge.

Determine the SNR_{SFN} for the case where all K intermediate stations EP forward at maximum transmitter power.

Compare the determined SNR_{SFN} with the intermediate station received signal-to-noise ratios SNR₁ₖ and deactivate all intermediate stations EP with SNR₁ₖ≦SNR_{SFN}.

End the routine when no further intermediate station EP is deactivated.

Determine the resulting SNR_{SFN} and go to step 2.

Because the SNR_{SFN} increases with each run through of the steps, the decisions of previous runs remain valid and therefore they do not have to be rechecked or corrected. This shows the convergent behavior of the algorithm, that has calculated an optimum result after at least K runs and then breaks off.

An activation criterion can also be defined in a similar manner to the activation criterion already described. In this case, a new intermediate station number L+1 is activated if its received signal-to-noise ratio (SNR_{1L+1}) is greater than the previous signal-to-noise ratio (SNR_{SFN L}) at the location of the receiving radio station, that has resulted from the previously active intermediate stations number 0 to L.

The described analyses can be performed separately for each OFDM subcarrier. To expand the preceding nomenclature to subcarriers, all that is required is to describe the system and channel parameters by subcarriers.

The following signaling concept can be derived from these criteria.

The receiving radio station, for example, periodically signals the determined reception signal-to-noise ratio SNR_{SFN}(f) for each OFDM subcarrier f to all intermediate stations EP.

Each intermediate station EP compares the signaled signal-to-noise ratio SNR_{SFN}(f) by subcarrier with the own determined reception signal-to-noise ratio SNR₁ₖ(f), whereby

where SNR₁ₖ(f)≦SNR_{SFN}(f), the intermediate station EP number k does not transmit a signal on the subcarrier f and

where SNR₁ₖ(f)>SNR_{SFN}(f), the intermediate station EP number k transmits at maximum power |Aₖ(f)|²≦1/(|H₁ₖ(f)|²+□₁ₖ²(f)) on this subcarrier f.

Without signaling (blind SFN forwarding in accordance with third method)

The signal-to-noise ratio at the location of the receiver (SNR_{SFN}) can be carried out without signaling only by taking into account locally known system parameters.

2.2.2 With Knowledge of the Phase of the Channel

In a second example, a system with intermediate stations EP is assumed to have knowledge of the channel phases of the transmitting channel for forwarding.

Because the phases of the H₂ₖ in the intermediate stations EP are not known, an advantageous constructive superposition of the signals at the receiver cannot always be achieved. The received signals superimpose each other with a random phase, which means that on average only the power of the received signals is added. The signal-to-noise ratio at the location of the receiving radio station can thus be calculated as follows.

$${SNR}_{SFN} = \frac{{( {\sum }_{k = 0}^{K - 1} \vert {H}_{1 k} \vert \vert {H}_{2 k} \vert \vert {A}_{k} \vert )}^{2}}{{σ}_{2}^{2} + {\sum }_{k = 0}^{K - 1} {σ}_{1 k}^{2} {\vert {H}_{2 k} \vert}^{2} {\vert {A}_{k} \vert}^{2}} .$$

This objective function SNR_{SFN} is now to be maximized using the variation of |Aₖ|². When doing so it must be noted that the parameters |Aₖ|² are limited. The optimization is therefore only to be carried out by limiting the given |Aₖ|² validity range.

2.2.2.1 With Channel Parameter Signaling and Received Value Signaling (MIMO Forwarding in Accordance with the First Method)

Optimization of the signal-to-noise ratio SNR_{SFN} can be advantageously carried out by signaling taking account of all system parameters.

2.2.2.2 With Channel Parameter Signaling (Adaptive SFN Forwarding in Accordance with the Second Method)

Optimization of the signal-to-noise ratio SNR_{SFN} with this signaling can be advantageously carried out taking account of the channel parameters.

A new preliminary investigation of the behavior of the objective function is helpful for maximization. This establishes that the height lines of the objective function hyperbolas of dimension K-1 or hyperboloids of dimension K-1 are in the R^{K}. This means that no height lines have a point characteristic and the function therefore has no global maximum or minimum within the validity range. This function is at the maximum on the edge of the validity range. By the main axis theory, it can also be shown that all hyperbolas have the same main axes.

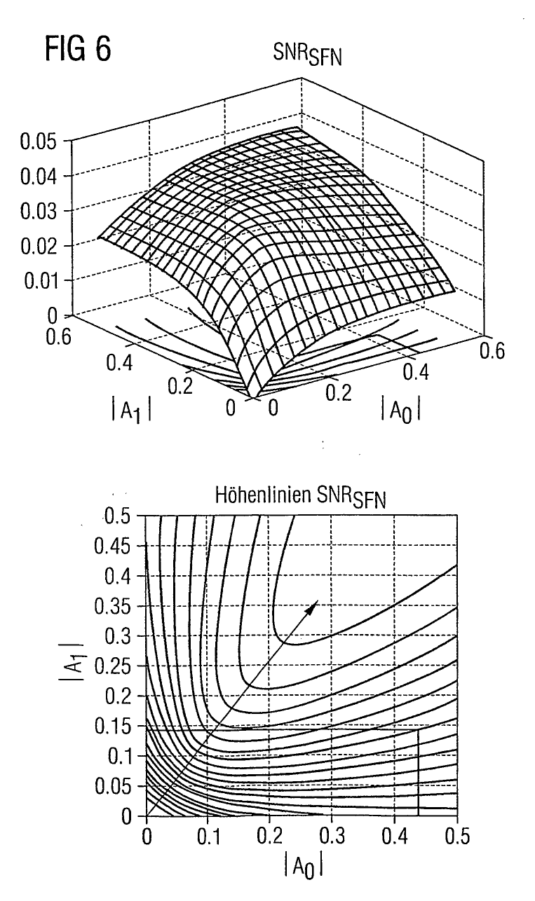

FIG. 6 shows an example of an objective function that demonstrates the signal-to-noise ratio SNR_{SFN} for two intermediate stations EP relative to the parameters |Aₖ|². The channel transmission factors were randomly chosen in this example. It can be seen that the height lines are hyperbolas and that the objective function is at maximum at the edge of the validity range. In the bottom illustration of FIG. 6, the validity range and the common main axis of the hyperbolas are shown in addition to the height lines.

An analysis shows that the objective function SNR_{SFN} is at a maximum on the edge of the validity range. The edges of the validity range can therefore be defined by hyper levels. In a first step, the adjacent hyper level on which the optimum is to be found is sought. As can be clearly seen from FIG. 6, it is the hyper level that is the “first” to be intersected by the main axis, i.e. the intersection point between the main axis and hyper level lies closest to the coordinate jump. With the aid of the main axis theory, it can be shown that a parameter set where |Aₖ|=□ □₂|H₁ₖ|/(□₁ₖ²|H₂ₖ|) lies on the main axis and a scalar □ describes the length of any chosen vector. A □ₖ is now chosen so that the weighting factor |Aₖ| is maximum. From this we get the following.

$${λ}_{k} = \sqrt{\frac{{SNR}_{2 k}}{{SNR}_{1 k}} \cdot \frac{1}{{SNR}_{1 k} + 1}}$$

The hyper level that is the first to be intersected by the main axis is characterized by the shortest vector and thus by the smallest value minₖ(□ₖ) of □ₖ.

In the following, it is considered useful to sort the numbering of the intermediate stations EP according to the size of the value □ₖ, SO that the intermediate station EP with the number k=0 has the smallest value □ₖ, and the sequence □ₖ [symbol] □ₖ₊₁ results.

This sorting means that □₀ is equal to minₖ(□ₖ), with the hyper level on which the maximum lies being defined by |A₀|²□1/(|H₁₀|²+□₁₀²). The intermediate station EP with the smallest value □ₖ must transmit at maximum transmitter power in order to maximize SNR_{SFN}. If several intermediate stations, for example N, have the same minimum value □₀=□ₖ for k<N, all N intermediate stations then transmit at maximum power.

$$\vert {A}_{k} \vert = \frac{1}{\sqrt{{\vert {H}_{1 k} \vert}^{2} + {σ}_{1 k}^{2}}} = \frac{1}{\sqrt{{σ}_{1 k}^{2} ( {SNR}_{1 k} + 1 )}} for 0 \leq k < N$$

By this forwarding by the N intermediate stations at maximum transmitter power we get the following signal-to-noise ratio at the location of the receiving radio station:

$$\begin{matrix}{SNR}_{N} = \frac{{( {\sum }_{k = 0}^{N - 1} \sqrt{\frac{{\vert {H}_{1 k} \vert}^{2} {\vert {H}_{2 k} \vert}^{2}}{{\vert {H}_{1 k} \vert}^{2} + {σ}_{1 k}^{2}}} )}^{2}}{{σ}_{2}^{2} + {\sum }_{k = 0}^{N - 1} \frac{{σ}_{1 k}^{2} {\vert {H}_{2 k} \vert}^{2}}{{\vert {H}_{1 k} \vert}^{2} + {σ}_{1 k}^{2}}} \\ = \frac{{( {\sum }_{k = 0}^{N - 1} \sqrt{\frac{{SNR}_{1 k} {SNR}_{2 k}}{{SNR}_{1 k} + 1}} )}^{2}}{1 + {\sum }_{k = 0}^{N - 1} \frac{{SNR}_{2 k}}{{SNR}_{1 k} + 1}} \\ = \frac{{( {\sum }_{k = 0}^{N - 1} {λ}_{k} {SNR}_{1 k} )}^{2}}{1 + {\sum }_{k = 0}^{N - 1} {λ}_{k}^{2} {SNR}_{1 k}}\end{matrix}$$

Fixing the transmitter power of the N intermediate stations defines an edge of the validity range, a hyper level of dimension K-N. In the following step, the maximum of the objective function at this hyper level is determined. This is to determine that the height lines of the objective function at this hyper level are generally ellipsoidal and exactly one height line degenerates to a point. The main axes theory shows that this point is defined by the following parameter set:

$$\vert {A}_{k} \vert = \frac{{σ}_{2} \vert {H}_{1 k} \vert}{{σ}_{1 k}^{2} \vert {H}_{2 k} \vert} \cdot {Λ}_{N} = \sqrt{\frac{{SNR}_{1 k}}{{σ}_{1 k}^{2} {SNR}_{2 k}}} \cdot {Λ}_{N} for N \leq k < K$$

$${Λ}_{N} = \frac{1 + {\sum }_{k = 0}^{N - 1} {λ}_{k}^{2} {SNR}_{1 k}}{{\sum }_{k = 0}^{N - 1} {λ}_{k} {SNR}_{1 k}}$$

In a final step, a check is made to determine whether the result lies within the validity range. The re-sorting carried out merely compares the calculated |Aₖ|² for k=N with the permissible maximum power. Similar to above, it can be shown that these intermediate stations with the number k=N must also transmit at maximum power, in order to achieve the optimum if the maximum power is exceeded by the calculated solution. The maximum power is exceeded in a case where □ₖ<□_{N}. The procedure is to be considered as previously described on the hyper level of dimension K-N-1 thus redefined.

If the intermediate stations transmit corresponding to the result of this calculation, the maximum SNR_{SFN} is achieved at the receiving radio station. In this case, the maximum SNR_{SFN} is as follows:

$${SNR}_{SFN} = {SNR}_{N} + {\sum }_{k = N}^{K - 1} {SNR}_{1 k}$$

Based on this deduction, an algorithm with the following steps can be formulated.

Calculate

$${λ}_{k} = \sqrt{\frac{{SNR}_{2 k}}{{SNR}_{1 k}} \cdot \frac{1}{{SNR}_{1 k} + 1}} for all 0 \leq k < K$$

and re-sort the indices k according to the sequence □ₖ [symbol] □ₖ₊1

Set N=1

Calculate

$${Λ}_{N} = \frac{1 + {\sum }_{k = 0}^{N - 1} {λ}_{k}^{2} {SNR}_{1 k}}{{\sum }_{k = 0}^{N - 1} {λ}_{k} {SNR}_{1 k}} ;$$

If □_{k=N}≦□_{N}, set N=N+1 and go to step 3.

Calculate the factors

$$\vert {A}_{k} \vert = \frac{1}{\sqrt{{σ}_{1 k}^{2} ( {SNR}_{1 k} + 1 )}} for 0 \leq k < N , or$$

$$\vert {A}_{k} \vert = \sqrt{\frac{{SNR}_{1 k}}{{σ}_{1 k}^{2} {SNR}_{2 k}}} \cdot {Λ}_{N} for N \leq k < K .$$

The iteration is discontinued when all the intermediate stations EP have been selected.

During the iteration, the value □_{□} has a behavior which enables the comparison to be performed individually for each intermediate station EP. In this case it is not necessary to consider whether several intermediate stations EP have equal □ₖ.

Furthermore, it is to be determined that for a selected intermediate station EP k≦N also applies after completion of the iteration □ₖ≦□_{N}. From this property and the above algorithm, the following signaling concept can be derived.

For example, all intermediate stations EP periodically transmit the SNR₁ₖ to the receiving radio station.

With these point-to-point connections, the receiving radio station determines the SNR₂ₖ by suitable measurements.

In the receiving radio station the final □_{□} is calculated by the above algorithm.

The receiving radio station, for example, periodically transmits the calculated □_{□} to all intermediate stations EP.

With this broadcast, each intermediate station EP individually determines the SNR₂ₖ by suitable measurements.

Each intermediate station EP individually calculates

$$the value \vert {A}_{k} \vert = \sqrt{\frac{{SNR}_{1 k}}{{σ}_{1 k}^{2} {SNR}_{2 k}}} \cdot {Λ}_{N} .$$

If the results exceed the maximum transmitter power of the intermediate station, it is limited to this maximum amount

$$\vert {A}_{k} \vert = \frac{1}{\sqrt{{σ}_{1 k}^{2} ( {SNR}_{1 k} + 1 )}}$$

and in future SNR₁ₖ is transmitted to the receiving radio station, otherwise the SNR₁ₖ does not need to be transmitted to the receiving radio station.

The intermediate stations EP begin forwarding the data received from the transmitting radio station.

If a new intermediate station EP is added

it also individually calculates the value

$$\vert {A}_{k} \vert = \sqrt{\frac{{SNR}_{1 k}}{{σ}_{1 k}^{2} {SNR}_{2 k}}} \cdot {Λ}_{N} .$$

If the result exceeds its maximum transmitter power, it is limited to this maximum value

$$\vert {A}_{k} \vert = \frac{1}{\sqrt{{σ}_{1 k}^{2} ( {SNR}_{1 k} + 1 )}}$$

and in future SNR₁ₖ is transmitted to the receiving radio station, otherwise the SNR₁ₖ does not need to be transmitted to the receiving radio station.

2.2.2.3 Without Signaling (Blind SFN Forwarding in Accordance with the Third Method)

The optimization of the signal-to-noise ratio at the location of the receiving radio station SNR_{SFN} can be performed without signaling only by taking account of the local known system parameters.

2.3 Three-Hop SFN (Single Frequency Network)

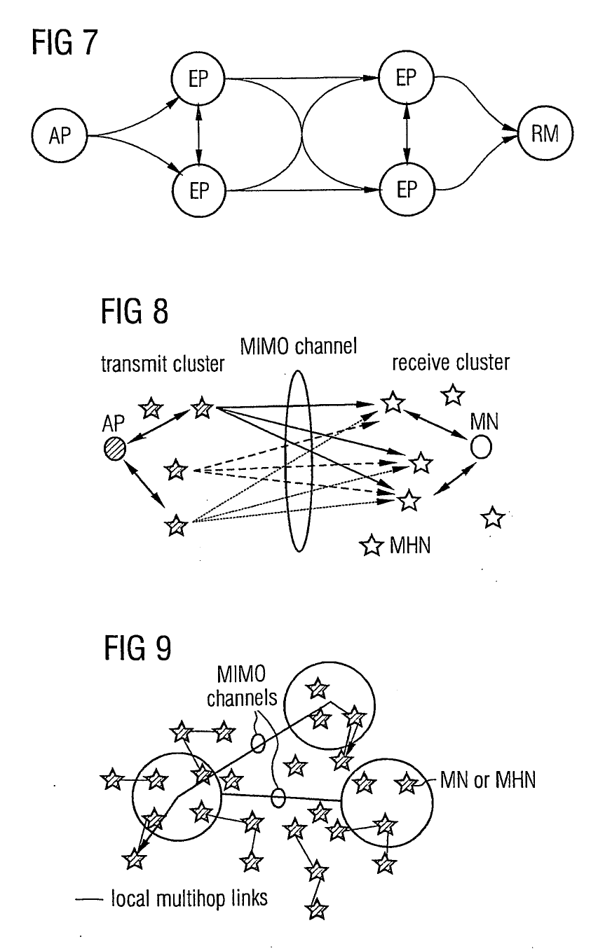

FIG. 7 shows a three-hop SFN system with intermediate stations EP. In this case, the transmission of data from a transmitting radio station AP to a receiving radio station RM takes place in three hops, for example by including two intermediate stations EP for each path.

2.3.1 With Knowledge of the Channel Phases

2.3.1.1 Channel Parameter Signaling and Received Value Signaling (MIMO Forwarding in Accordance with the First Method)

The optimization of the signal-to-noise ratio at the location of the receiving radio station SNR_{SFN} can be performed by signaling taking account of all system parameters.

2.3.1.2 With Channel Parameter Signaling (Adaptive SFN Forwarding in Accordance with the Second Method)

Optimization of the signal-to-noise ratio at the location of the receiving radio station SNR_{SFN} can be performed using signaling taking account of all system parameters.

2.3.1.3 Without signaling (blind SFN forwarding in accordance with the third method)Optimization of the signal-to-noise ratio at the location of the receiving radio station SNR_{SFN} can be performed without signaling only by taking account of the locally known system parameters.

In accordance with one system, several individual radio stations and/or intermediate stations EP cooperate and form a distributed, smart antenna. The individual antenna elements in this case are typically omnidirectional antennas of the radio stations or intermediate stations EP. If several clusters of antennas in an ad-hoc network are combined to form a distributed antenna, MIMO (multiple input multiple output) can be advantageously formed in this way, in order, for example, to achieve spatial multiplexing. MIMO channels, for example corresponding to the known BLAST principle, enable a very high spectral efficiency in bit/s/Hz.

The clustering of antennas enables hierarchy levels to be introduced in ad-hoc networks. To transmit over great distances, for example, the powerful MIMO channels are used, whereas shorter distances are bridged using the known multihop transmission system via several intermediate stations. In this way, scalable ad-hoc networks can also be realized in cases where transmission is not locally limited.

Depending on the algorithm, such MIMO antennas require a coupling of the individual antennas or antenna elements, which requires an additional signaling, for example for the exchange of channel estimates. The distributed concept has the advantage that the radio or intermediate stations can be realized without expensive and large antennas with associated HF front ends, and therefore a very high spectral efficiency for the distributed MIMO antennas is enabled.

MIMO methods furthermore typically require that the radio channels between the individual antenna elements are uncorrelated. Depending on the environment, the antenna elements should therefore have a spacing amounting to several wavelengths of the transmission frequency used. This requirement is particularly easy to meet for distributed antennas. In principle, all known smart antenna concepts such as SDMA (Space Division Multiple Access) or controllable antennas with interference reduction can be realized using distributed antennas.

The following description deals with a further possible cooperation between several radio or intermediate stations in an SFN (single frequency network). In SFNs, a special multihop method can be used, whereby several intermediate stations simultaneously transmit data to a very remote receiving radio station RM (Remote Mobile Terminal). By an exchange of information between the intermediate stations EP, as already described, and suitable selected weighting factors in the intermediate stations EP, substantial gain compared with the known SFN networks can be achieved. This amounts to that achieved with known maximum ratio combining methods. Generally, the method of distributed antennas has the advantage that the performance capability increases with the increasing number of radio or intermediate stations, i.e. the method adapts itself automatically to the normally increased amount of data in cases where there are several stations.

FIG. 8 shows the clusters of several intermediate stations MHN (multihop nodes), both at the transmission end, transmit cluster, and at the reception end, receive cluster, in order in each case to configure a distributed MIMO antenna for spatial multiplexing to form a MIMO channel, MIMO channel. In contrast to known MIMO antennas, in this case there is no direct wired connection between the individual antenna elements of the particular cluster. The spatial multiplexing combines the signals of all the receiving antenna elements and from this determines the resulting data flow. This concept enables an exchange of signaling information between the distributed antennas or stations, such as data regarding particular channel estimations.

FIG. 9 further shows an example of an application of a distributed antenna concept in an ad-hoc network. In this case, the MIMO channels, MIMO channels, are used to construct the connection between remote installations of the ad-hoc network. Shorter distances, such as those requiring few hops, are bridged using known multihop connections, local multihop links, because frequency and time resources can be spatially reused in this way. The circuits in FIG. 9 each show examples of a cluster having of several intermediate stations MHN (multihop node) or receiving radio stations MN, that in each case react corresponding to a smart antenna and enable transmission to a further remote cluster. Advantageously, the clustering of parts of the ad-hoc network very remote from each other achieves a higher spectral efficiency, which facilitates the scalability of the overall network.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means on or more of A, B and C may be used, contrary to the holding in Superguide v. DIRECTV, 69 USPQ2d 1865 (Fed. Cir. 2004).

1-10. (canceled)

11. A method for transmitting signals in a radio communication system, comprising:
transmitting signals from a first radio station via at least two intermediate stations to a second radio station; and
signaling between the at least two intermediate stations to configure transmission from the first radio station to the second radio station.

12. The method in accordance with claim 11, wherein
characteristic quantities are signaled between the at least two intermediate stations and the first and/or second radio station.

13. The method in accordance with claim 11, wherein
characteristic quantities are determined in the intermediate stations from signals received from the first and/or second radio station.

14. The method in accordance with claim 12, wherein
the characteristic quantities are used in the intermediate stations to determine weighting factors.

15. The method in accordance with claim 14, wherein
the characteristic quantities contain information on channel properties.

16. The method in accordance with claim 15, wherein
information on the channel properties is updated only if there is a change in channel properties.

17. The method in accordance with claim 11, wherein
antenna devices of the at least two intermediate stations are configured to correspond to antenna elements of a smart antenna.

18. The method in accordance with claim 11, wherein
signals are transmitted from the first radio station to the second radio station via a plurality of intermediate stations located in a radio coverage area of the first radio station and via a plurality of intermediate stations located in a radio coverage area of the second radio station,
antenna devices of the intermediate stations located in the radio coverage area of the first radio station are grouped to form a first smart antenna, and
antenna devices of the intermediate stations located in the radio coverage area of the second radio station are grouped to form a second smart antenna.

19. The method in accordance with claim 11, wherein
pre-equalization or equalization procedures are used in the intermediate stations for data transmission.

20. The method in accordance with claim 11, wherein
transmission between the at least two intermediate stations takes place in accordance with a single frequency network.

21. The method in accordance with claim 13, wherein
the characteristic quantities are used in the intermediate stations to determine weighting factors.

22. The method in accordance with claim 21, wherein
the characteristic quantities contain information on channel properties.

23. The method in accordance with claim 22, wherein
information on the channel properties is updated only if there is a change in channel properties.

24. The method in accordance with claim 23, wherein
antenna devices of the at least two intermediate stations are configured to correspond to antenna elements of a smart antenna.

25. The method in accordance with claim 24, wherein
signals are transmitted from the first radio station to the second radio station via a plurality of intermediate stations located in a radio coverage area of the first radio station and via a plurality of intermediate stations located in a radio coverage area of the second radio station,
antenna devices of the intermediate stations located in the radio coverage area of the first radio station are grouped to form a first smart antenna, and
antenna devices of the intermediate stations located in the radio coverage area of the second radio station are grouped to form a second smart antenna.

26. The method in accordance with claim 25, wherein
pre-equalization or equalization procedures are used in the intermediate stations for data transmission.

27. The method in accordance with claim 26, wherein
transmission between the at least two intermediate stations takes place in accordance with a single frequency network.
